(19) United States
(12) Patent Application Publication
(10) Pub. No.: US 2023/0255229 A1
(43) Pub. Date: Aug. 17, 2023

(54) A METHOD AND SYSTEM FOR PRODUCING SOFT CONFECTIONERY

(71) Applicant: Tanis Confectionery B.V., Oosterhout (NL)

(72) Inventor: Leonard Johannes TANIS, Oosterhout (NL)

(21) Appl. No.: 18/017,193

(22) PCT Filed: Jul. 23, 2021
(86) PCT No.: PCT/NL2021/050473

§ 371 Date: Jan. 20, 2023

(30) Foreign Application Priority Data
Jul. 24, 2020 (NL) 2026139

(51) Int. Cl. A23G 3/34; A23G 3/02; A23G 7/02; A23G 7/00; A23G 3/42

(52) U.S. Cl. CPC A23G 3/0031; A23G 3/0027; A23G 3/0257; A23G 3/0268; A23G 7/02; A23G 7/0093; A23G 3/42

(57) ABSTRACT

A method and system for producing confectionery, wherein a tray with one or more mould cavities formed in moulding powder, such as starch, is provided. The moulding powder has an initial moisture content. Depositing liquid confectionery in the one or more mould cavities causes the moisture content of the moulding powder to increase. The tray is provided in a conditioning room configured for drying the deposited confectionery. The conditioning parameters of the conditioning room are adapted such that the moulding powder is dried to a desired moisture content, wherein the desired moisture content is such that the moulding powder is suitable for immediate re-use in subsequent confectionery production.

### FIELD OF THE INVENTION

The invention relates to a method and system for producing soft confectionery by means of a tray including one or more mould cavities formed in moulding powder.

### BACKGROUND TO THE INVENTION

Confectionery such as wine gums, gummy confections, gummy jellies, sweets/candy, etc. may have a firm structure with a softness and chewiness conferred by gelatin, starch and/or pectin based gels or other. The confectionery may include gelling agents, sugars, water and other components like starch syrups from different origin.

Commonly, moulding powder, such as starch, is used as a forming and drying agent in confectionery production. The confectionery can be produced by stamping desired shapes into a moulding powder bed on a tray. A liquid confectionery mass is then poured into cavities formed in the moulding powder bed. After moulding, the confectionery product can set and dry, optionally by air convection tunnels or chambers in order to achieve a consistent solid matrix that matches the desired confectionary product characteristics. The moulding powder on the tray can ensure easy removal of the formed confectionery, avoiding sticking to a surface of the tray. The texture of the formed confectionery can become firm in time due to gelling and as the moisture content decreases, i.e. drying. The used drying conditions depend on i.a. the size of the confectionery product, the confectionery composition, the type of product to be obtained (e.g. crusted or not), etc.

Typically, the moulding powder filled trays with deposited confectionery mass is placed in a conditioning room for a period of around 18-72 hours. In the conditioning room, a particular airflow with maintained set point temperature and humidity can give the candy the desired shape and product characteristics. In the conditioning room the gelling agent in the confectionery will gel. Gelling will give the confectionery some firmness. However, a confectionery product that has only gelled and has not additionally dried, i.e. lost water content, is generally considered not suitable for further processing. A shelf-life of the confectionery products is created due to the lower water activity level by drying. The drying of the confectionery may also provide an adequate strength of the confectionery product for subsequent handling such as to avoid risking deformation and/or breaking.

During the drying process of the confectionery in the conditioning room, the deposited confectionery is dried by moisture pick up by the moulding powder, but also by the (circulated) process air of which the temperature and (relative) humidity are controlled. The moulding powder, in stationary situation, can pick up typically between 0.5-5 w/w % typically between 1-3 w/w % moisture during the confectionery conditioning/drying process of the confectionery in the conditioning room. At the end of the drying process in the conditioning room, the confectionery is separated from the moulding powder. The moisture level of the moulding powder is increased during the confectionery drying process to a level making direct re-use unsuitable. Herein unsuitable means that the functionality of the moulding powder as forming agent and as dehydration powder for the confectionery poured in the cavities is lost or at least diminished to undesired extent. Frequent replacement of the moulding powder may be costly and/or time consuming.

Commonly, after de-moulding of the confectionery the moulding powder with increased moisture content is dried using a drying equipment. Generally, the drying of the moulding powder takes place in a separate continuous installation which contains a filter, dryer, cooler and buffer, all connected by a dedicated system of transport screws or other specific design starch drying equipment. After having passed the dryer, the moisture level of the moulding powder is reduced to the required levels and is only then ready for re-use in the candy forming and candy drying process.

The operational drying parameters of the dedicated moulding powder drying equipment are often selected for maximizing the efficiency in reducing the moisture content of the moulding powder to a desired moisture content. Often, large and bulky drying equipment are used in which the moulding powder is dried rather intensively.

### SUMMARY OF THE INVENTION

It is an object of the invention to provide for a method and a system that obviates at least one of the above mentioned drawbacks.

Additionally or alternatively, it is an object of the invention to improve the efficiency of a confectionery production process.

Additionally or alternatively, it is an object of the invention to improve drying of moulding powder used in confectionery production.

Thereto, the invention provides for a method for producing confectionery, the method including: providing a tray with one or more mould cavities formed in moulding powder, such as starch, wherein the moulding powder has an initial moisture content; depositing liquid confectionery in the one or more mould cavities causing the moisture content of the moulding powder to increase; and providing the tray in a conditioning room configured for drying the deposited confectionery; wherein conditioning parameters of the conditioning room are adapted such that the moulding powder is dried to a desired moisture content, wherein the desired moisture content is such that the moulding powder is suitable for immediate re-use in subsequent confectionery production. The conditioning parameters of the conditioning room are adapted such that the confectionery is gelled and dried to a desired extent simultaneously. Herein suitable for immediate re-use means that the moulding powder can immediately, i.e. without intervening drying step or drying time, be used in a tray for moulding a next batch of confectionery product.

The inventors have found that in general it is possible to set the conditioning parameters of the conditioning room such that the confectionery deposited in the moulding powder is not only gelled but also dried so as to be suitable for further processing, such as handling for packaging. The drying of the confectionery product is critical. Too little drying will compromise shelf life. Too much drying will result in tough product which generally is perceived as undesirable. Therefore, the extent of drying in the conditioning room is determined by the confectionery product. That the moulding powder to some extent also dries in the conditioning room has hitherto been nothing more than a beneficial side effect. The drying of the moulding powder in the conditioning room of which the conditioning parameters are set for optimally gelling and drying the confectionery product, however, has always been insufficient to be able to simultaneously dry the moulding powder to a moisture content that is suitable for immediate re-use. The inventors, however, have found that it is possible to set the conditioning parameters of the conditioning room such that the confectionery product is gelled and dried to a desired extent, and that simultaneously the moulding powder is dried to a desired moisture content, wherein the desired moisture content is such that the moulding powder is suitable for immediate re-use in subsequent confectionery production

The conditioning parameters of the conditioning room can be selected for drying the moulding powder to a level making the moulding powder directly re-usable in subsequent confectionery production without requiring a further separate/dedicated moulding powder drying step. The conditioning parameters of the conditioning room can be adapted so as to simultaneously treat the confectionery and dry the moulding powder, wherein the moisture level of the moulding powder is controlled during treatment of the soft confectionery in the conditioning room. The moulding powder drying step can be integrated in the confectionery conditioning step. In this way, the efficiency of the total process of confectionery production can be improved. Also the production costs may be reduced.

Advantageously, the moulding powder used during confectionery production can be dried in the conditioning room to the desired moisture content, rather than in a separate dedicated moulding powder conditioning room or drying room. Such a dedicated moulding powder conditioning may thus no longer be required. Alternatively, a smaller dedicated moulding powder conditioning equipment (e.g. room) can be employed, e.g. for further drying the moulding powder after the desired moisture content has been reached in the conditioning room. The complexity of the confectionery production process can be significantly reduced, as the drying of the moulding powder can be integrated in the conditioning room used for conditioning the confectionery. Optionally, a dedicated drying room different for drying the moulding powder is omitted.

Optionally, the desired moisture content is substantially equal to or lower than the initial moisture content. Hence the re-used moulding powder does not have a higher moisture content than the initial moulding powder. Thus the confectionery produced using the re-used moulding powder can have the same properties as the confectionery produced using the initial moulding powder.

Both the confectionery as well as the moulding powder can be simultaneously dried in the same conditioning room for obtaining the reduced moisture content. The conditioning parameters can be chosen such that also the moulding powder is dried. The tray with the deposited confectionery may be kept in the conditioning room for a predetermined period of time. The duration of treatment in the conditioning room may be chosen in order to allow sufficient drying of the moulding powder therein. Instead of high intensive drying afterwards (e.g. for 2 to 30 minutes) in a dedicated drying system, the moulding powder can be dried in the conditioning room, so that a smaller moulding powder dryer can be employed, or that the moulding powder dryer can be omitted in the confectionery production process.

The conditioning parameters for drying the deposited confectionery and the moulding starch simultaneously can be adapted in dependence of the type of gelling agent in the confectionery. Common gelling agents are gelatin, pectin or starch, other, or combinations thereof.

Preferably, the confectionery product is dried such that the moisture content of the confectionery is decreased by 3-20%. More specifically, in confectionery containing gelatin, pectin, or a combination thereof as gelling agent the moisture content is preferably decreased by 3-17%. In confectionery containing starch as gelling agent the moisture content is preferably decreased by 8-20%.

Tests and measurements, i.a. with standard gelatin confectionery mass, have shown that from the start of the conditioning process in the conditioning room, the moisture level of the moulding powder first increases, generally during a first time interval of the first four to eight hours after depositing. This increase of the moisture content of the moulding powder, is a result of the moulding powder desiccating the confectionery mass. Therefore, the moisture content of the confectionery decreases simultaneously with the increase of moisture content of the moulding powder within ratio in the same period of time. Generally, after a certain period of time (e.g. within four to eight hours) the maximum moisture content of the moulding powder is reached. After that moment, during a second time interval the moisture content of the confectionery and the moulding powder both decrease. The conditioning parameters of the conditioning room are chosen such that by the end of the second interval the confectionery has dried to the desired extent and the moisture content of the moulding powder has decreased to, or close to, its original value and is directly ready for re-use without passing a dedicated moulding powder only dryer.

Preferably, the conditioning parameters are chosen such that an air flow is between 0.2-1.5 m/s, a temperature in the conditioning room is between 20-75 degrees Centigrade, and a humidity in the conditioning room is between 2-130 gr H₂O/kg air. The time period that the tray with the confectionery and the moulding powder remains in the conditioning room is preferable between 6-65 hours. More specifically, for confectionery containing gelatin as gelling agent the conditioning parameters are chosen such that an air flow is between 0.2-1.5 m/s, a temperature in the conditioning room is between 20-35 degrees Centigrade, a humidity in the conditioning room is between 2-13.5 gr H₂O/kg air, and the time period that the tray with the confectionery and the moulding powder remains in the conditioning room is preferable between 8-36 hours. For confectionery containing pectin as gelling agent the conditioning parameters are chosen such that an air flow is between 0.2-1.5 m/s, a temperature in the conditioning room is between 28-55 degrees Centigrade, a humidity in the conditioning room is between 2-30 gr H₂O/kg air, and the time period that the tray with the confectionery and the moulding powder remains in the conditioning room is preferable between 6-48 hours. For confectionery containing a combination of gelatin and pectin as gelling agent the conditioning parameters are chosen such that an air flow is between 0.2-1.5 m/s, a temperature in the conditioning room is between 20-35 degrees Centigrade, a humidity in the conditioning room is between 2-16 gr H₂O/kg air, and the time period that the tray with the confectionery and the moulding powder remains in the conditioning room is preferable between 8-48 hours. For confectionery containing starch as gelling agent the conditioning parameters are chosen such that an air flow is between 0.2-1.5 m/s, a temperature in the conditioning room is between 45-75 degrees Centigrade, a humidity in the conditioning room is between 2-130 gr H₂O/kg air, and the time period that the tray with the confectionery and the moulding powder remains in the conditioning room is preferable between 30-65 hours.

Optionally, the desired moisture content and the initial moisture content are substantially the same. In this way, it may no longer be required to have a separate dedicated dryer arranged for drying the moulding powder. Instead, the moulding powder with increased moisture content resulting from the deposited liquid confectionery can be dried so as to obtain the desired moisture content substantially equal to the initial moisture content. Hence, the dried moulding powder can be suitable for direct re-use in a subsequent confectionery production process.

In some examples, it is guaranteed that the moisture content is reduced to substantially the initial moisture content. Optionally, process parameters and/or conditioning parameters are adjusted such as to minimize a difference between the initial moisture content and the desired moisture content.

Optionally, the method further includes using the moulding powder dried in the conditioning room in a subsequent confectionery production process. Optionally, the method further includes using the moulding powder dried in the conditioning room in a subsequent confectionery production process without intermediate additional drying step.

Optionally, the moulding powder is dried in the conditioning room to a moisture content in a range of 4 to 14 w/w %, more preferably in a range of 6 to 10 w/w %.

Optionally, an absolute humidity (e.g. mixing ratio, gr H₂O/kg air) in a range between 0.05-240 gr H₂O/kg air is employed, preferably between 0.15-85 gr H₂O/kg air.

Optionally, the moulding powder is dried in the conditioning room to the desired moisture level prior to removing the soft confectionery from the tray. Hence, while the soft confectionery is being conditioned to a state ready for de-moulding the moulding powder is dried to the desired moisture content suitable for immediate re-use in subsequent confectionery production.

The soft confectionery may be conditioned in the conditioning room. Furthermore, the increased moisture content of the moulding powder as a result of deposition of the soft confectionery can be actively reduced, e.g. to the initial moisture content, without the soft confectionery being removed from the tray. Advantageously, the moulding powder can be directly usable in a successive process for producing soft confectionery.

Optionally, the conditioning parameters include at least one of a temperature, humidity, air flow rate, or irradiation.

Optionally, the conditioning room has an air temperature in a range between 10 and 80 degrees Celsius, preferably in a range between 20 and 60 degrees Celsius, and optionally the conditioning room has an absolute humidity level (mixing ratio, gr H₂O/kg air) in a range between 0.05-240 gr H₂O/kg air preferably between 0.15-85 gr H/kg air. Optionally, the tray is kept in the conditioning room for 6-72 hours, such as for 8 to 72 hours.

Optionally, prior to removing the soft confectionery from the tray, the soft confectionery is cooled, wherein cooling is performed in the conditioning room. Optionally, the cooling is performed by applying conditioning parameters preventing moisture pick up by confectionery product and/or moulding powder.

Optionally, a plurality of trays are handled in succession in a continuous or batch process.

According to an aspect, the invention provides for a system including means for carrying out the method according to the invention.

Advantageously, it may no longer be necessary to guide the remaining moulding powder to a dedicated dryer for drying the moulding powder after removal of the formed confectionery product. Instead, the moulding powder can be dried in the conditioning room to a desired moisture content suitable for re-use in a further soft confectionery production process. Alternatively, a smaller moulding powder dryer can be used, e.g. for further drying of the moulding powder after the desired moisture content has been reached in the conditioning room. Advantageously, the required floor space and/or the total investment level can be reduced. Furthermore, a shorter return of investment (ROI) can be obtained employing the method according to the invention.

According to an aspect, the invention provides for a system for producing soft confectionery, the system including: a tray for receiving moulding powder, such as starch, wherein the moulding powder has an initial moisture content, a moulding member for forming one or more mould cavities in the moulding powder, a depositing unit configured to deposit liquid confectionery in the one or more mould cavities, causing the moisture content of the moulding powder to increase, a conditioning room configured for drying the soft confectionery, wherein the system is configured to provide the tray in the conditioning room, wherein conditioning parameters of the conditioning room are adapted such that the moulding powder is dried to a desired moisture content, wherein the desired moisture content is such that the moulding powder is suitable for immediate re-use in subsequent confectionery production.

According to an aspect, the invention provides for a method for producing confectionery, the method including: providing a tray with one or more mould cavities formed in moulding powder, such as starch, wherein the moulding powder has an initial moisture content; depositing liquid confectionery in the one or more mould cavities causing the moisture content of the moulding powder to increase; and providing the tray in a conditioning room configured for drying the deposited confectionery; wherein conditioning parameters of the conditioning room are adapted such that the moulding powder is dried to a desired moisture content, wherein the desired moisture content is substantially equal to or lower than the initial moisture content.

According to an aspect, the invention provides for a method for producing soft confectionery, the method including: providing a tray with one or more mould cavities formed in moulding powder, such as starch, wherein the moulding powder has an initial moisture content; depositing liquid confectionery in the one or more mould cavities; and providing the tray in a conditioning room configured for treating the soft confectionery; wherein conditioning parameters of the conditioning room are adapted such that the moulding powder is dried to a desired moisture content suitable for re-use in a subsequent soft confectionery production process.

It will be appreciated that any of the aspects, features and options described in view of the methods apply equally to the system and vice versa. It will also be clear that any one or more of the above aspects, features and options can be combined.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIG. 1 shows a schematic diagram of a method;

FIG. 2 shows a schematic diagram of a system; and

FIG. 3 shows a schematic diagram of a graph.

### DETAILED DESCRIPTION

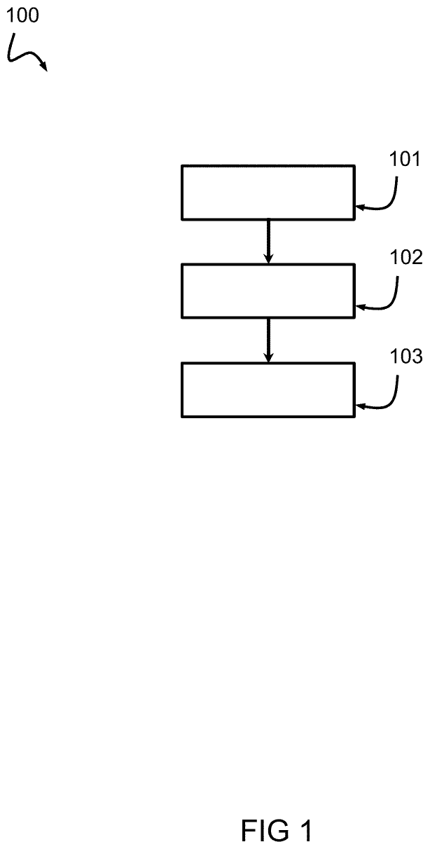

FIG. 1 shows a schematic diagram of a method 100 for producing soft confectionery. In a first step 101, a tray with one or more mould cavities formed in moulding powder, such as starch, is provided, wherein the moulding powder has an initial moisture content. In a second step 102, liquid confectionery is deposited in the one or more mould cavities causing the moisture content of the moulding powder, e.g. near the mould cavities, to increase. In a third step 103, the tray is provided in a conditioning room configured for drying the deposited confectionery.

Conditioning parameters of the conditioning room are adapted such that the moulding powder is dried to a desired moisture content, wherein the desired moisture content is such that the moulding powder is suitable for immediate re-use in subsequent confectionery production.

The moulding powder can be re-used in a subsequent confectionery production process since the moulding powder is sufficiently dried in the conditioning room. The moulding powder can be dried to a desired moisture level in a same room used for conditioning the soft confectionery. For this purpose, the conditioning of the soft confectionery can be adapted.

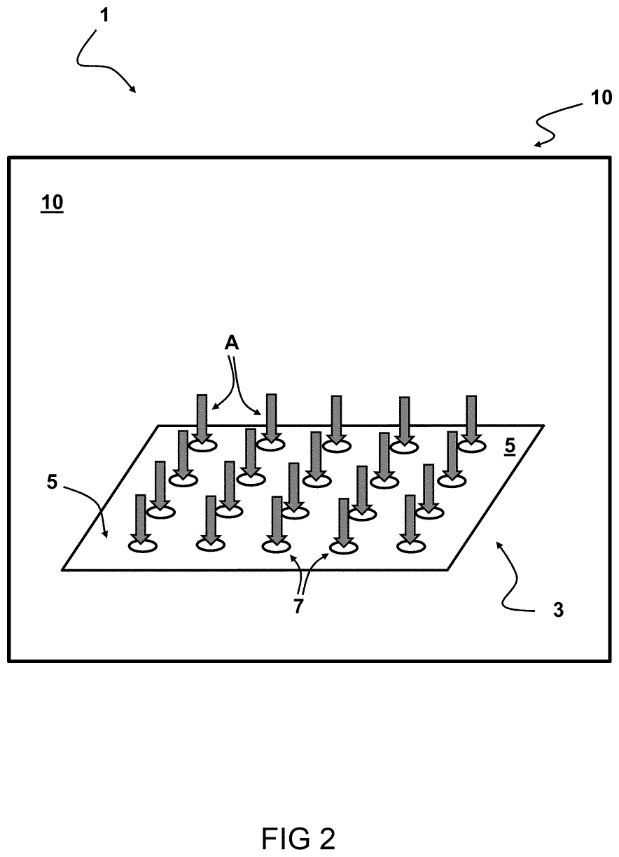

FIG. 2 shows a schematic diagram of a system 1 for producing soft confectionery. The system includes a tray 3 for receiving moulding powder 5, such as starch, wherein the moulding powder 5 has an initial moisture content. The system further includes a moulding member (not shown) for forming one or more mould cavities 7 in the moulding powder 5. Further, the system includes a depositing unit (not shown) configured to deposit liquid confectionery, depicted with arrows A, in the one or more mould cavities 7 formed in the moulding powder 5. Depositing the liquid confectionery in the mould cavities causes the moisture content of the moulding powder, starting at the mould cavities 7, to increase. The system further comprises a conditioning room 10 configured for drying the soft confectionery. The system 1 is configured to provide the tray 3 in the conditioning room 10. Conditioning parameters of the conditioning room are adapted for drying the soft confectionery. Conditioning parameters of the conditioning room are also adapted such that the moulding powder 5 is dried to a desired, e.g. reduced, moisture content, wherein the desired moisture content is such that the moulding powder 5 is suitable for immediate re-use in subsequent confectionery production. In this example, the desired moisture content reached at F is substantially equal to the initial moisture content at B. It will be appreciated that while the deposited soft confectionery dries in the conditioning room also the moulding powder 5 is dried to the desired moisture content. After drying of the soft confectionery the soft confectionery can be removed from the tray 3. The moulding powder 5 can be removed from the tray 3, e.g. simultaneous with removing the dried soft confectionery from the tray 3, e.g. by turning the tray over. Thus, upon de-moulding of the dried soft confectionery the moulding powder has already been dried to the desired moisture content suitable for immediate re-use in subsequent confectionery production.

In this way, the effect of locally increased moisture content at the cavities formed in the moulding powder can be reduced in the conditioning room 10, thereby making the process of producing soft confectionery more efficient. It is not necessary to separately treat the moulding powder 5, for instance in a separate unit, in order to reduce to moisture content for re-use in a subsequent soft confectionery production process. In some examples, the moisture content after deposition of the soft confectionery in the moulding cavities 7 can be reduced to an initial moisture content.

The conditioning parameters of the conditioning room 10 can e.g. include an air temperature in a range between 10 and 80 degrees Celsius, preferably in a range between 20 and 60 degrees Celsius, an absolute humidity level in a range between 0.05-240 gr H₂O/kg air, preferably between 0.15-85 gr H₂O/kg air, and the tray can be kept in the conditioning room for 8 to 72 hours.

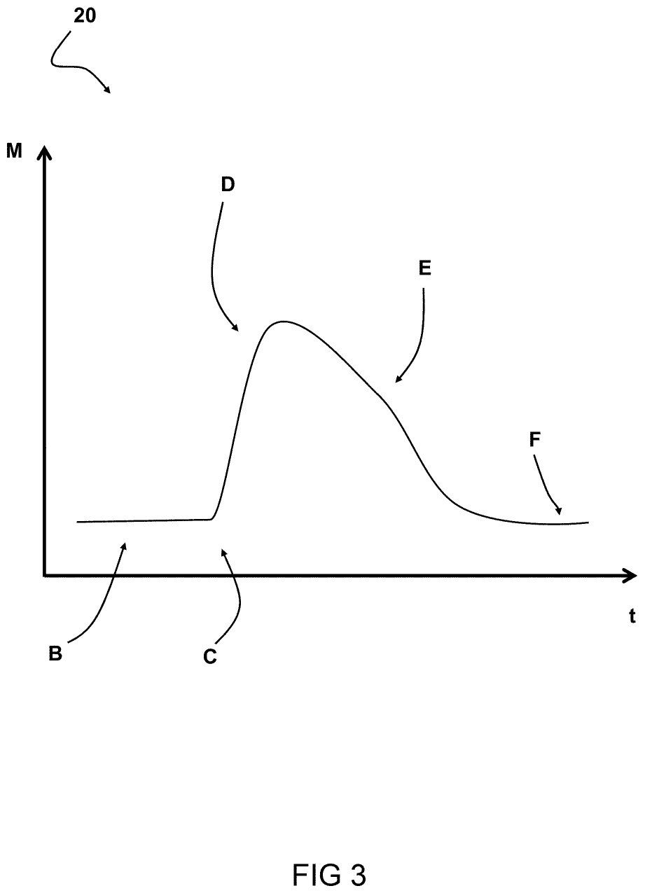

FIG. 3 shows a schematic diagram of a graph 20 representing moisture content M in function of time t. This moisture content may be an indication of an average moisture content of the moulding powder 5. However, it may also represent the moisture content at or near the moulding cavities 7 formed in the moulding powder 5. When the soft confectionery has not yet been deposited in the moulding cavities 7, the moisture content is constant (see B). After deposition of the soft confectionery in the moulding cavities 7, the moisture content is increased (see C). The moisture content increases due to the moulding powder absorbing moisture from the deposited soft confectionery, i.e. the confectionery is dried. As a result of the depositing, the moisture content is increased until a peak is reached (see D). The peak can generally be reached after 6-8 hours. After reaching the peak at D both the confectionery and the moulding powder are dried (see E-F).

The tray is provided in a conditioning room 10 configured for drying the deposited soft confectionery, normally shortly after depositing (at C). The conditioning parameters of the conditioning room 10 are selected such that the confectionery is gelled and dried to a desired extent (see C-F), and that simultaneously that the moulding powder 5 is dried to a desired moisture content (see E-F). While in the conditioning room 10, a top surface of the moulded soft confectionery, which is not in contact with the moulding powder, will be dried. However, since the moulding powder initially absorbs moisture, and later also is dried, bottom and side surfaces of the moulded confectionery, which are in contact with the drying moulding powder, will continually be dried by the moulding powder. Hence, the moulded soft confectionery will be dried efficiently as well. The desired moisture content to which the moulding powder is dried (see F) is selected such that the moulding powder 5 is suitable for immediate re-use in subsequent confectionery production, i.e. without additional drying step or drying time. In some examples, the moulding powder, such as starch, does not require further drying, but one or more further operations may be carried out. For example, a sieving and/or mixing action can be further carried out prior to re-use in a subsequent confectionery production process.

The conditioning parameters for drying the deposited confectionery and the moulding starch simultaneously can be adapted in dependence of the type of gelling agent in the confectionery. Common gelling agents are gelatin, pectin or starch, other, or combinations thereof. The table below shows typical values for conditioning the confectionery mass with simultaneously drying a starch moulding powder.

| | | | | | | Temperature | Humidity |
|---|---|---|---|---|---|---|---|
| | | | After | Decrease | | process air | process air |
| | | Deposit | conditioning | moisture | | during | during |
| Gelling | | dry | dry matter | content | Duration of | conditioning | conditioning |
| agent | Airflow | matter | candy | candy | conditioning | for drying | for drying |
| (type) | (m/s) | (%) | (%) | (%) | (hrs) | (° C.) | (gr H₂O/kg) |
| Gelatin | 0.2-1.5 | 75-82 | 80-92 | [symbol] 3-17 | 8-36 | 20-35 | 2-13.5 |
| Pectin | 0.2-1.5 | 75-82 | 80-92 | [symbol] 3-17 | 6-48 | 28-55 | 2-30 |
| Gelatin/pectin | 0.2-1.5 | 75-82 | 80-92 | [symbol] 3-17 | 8-48 | 20-35 | [symbol] 2-16 |
| Starch | 0.2-1.5 | 70-78 | 78-90 | 8-20 | 30-65 | 45-75 | 2-130 |
| Other | . . . | . . . | . . . | . . . | . . . | . . . | . . . |

Although the procedures of for example the methods and processes described herein may be described in a particular order for ease of description, unless the context dictates otherwise, various procedures may be reordered, added, and/or omitted in accordance with various embodiments. Furthermore, the procedures described with respect to one method or process may be incorporated within other described methods or processes. Likewise, system components described according to a particular structural architecture and/or with respect to one system may be organized in alternative structural architectures and/or incorporated within other described systems. Therefore, while various embodiments are described with or without certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

It will be appreciated that the method may include computer implemented steps.

Herein, the invention is described with reference to specific examples of embodiments of the invention. It will, however, be evident that various modifications, variations, alternatives and changes may be made therein, without departing from the essence of the invention. For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the spirit and scope of the appended claims. Further, many of the elements that are described are functional entities that may be implemented as discrete or distributed components or in conjunction with other components, in any suitable combination and location.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A method for producing soft confectionery, the method including:
providing a tray with one or more mould cavities formed in moulding powder, such as starch, wherein the moulding powder has an initial moisture content;
depositing liquid confectionery in the one or more mould cavities causing the moisture content of the moulding powder to increase; and
providing the tray in a conditioning room configured for drying the deposited confectionery;
wherein conditioning parameters of the conditioning room are adapted such that the confectionery is gelled and dried to a desired extent, and that simultaneously the moulding powder is dried to a desired moisture content, wherein the desired moisture content is such that the moulding powder is suitable for immediate re-use in subsequent confectionery production; and
in the conditioning room gelling and drying the confectionery to the desired extent and drying the moulding powder to the desired moisture level prior to removing the confectionery from the tray.

2. The method according to claim 1, wherein the desired moisture content is substantially equal to or lower than the initial moisture content.

3. The method according to claim 1, wherein the desired moisture content and the initial moisture content are substantially the same.

4. The method according to claim 1, wherein the moulding powder is dried in the conditioning room to a moisture content in a range of 4 to 14 w/w %, more preferably in a range of 6 to 10 w/w %.

5. The method according to claim 1, wherein the confectionery is dried in the conditioning room such that the moisture content of the confectionery is decreased by 3-20%.

6. The method according to claim 1, wherein the conditioning parameters include at least one of a temperature, humidity, air flow rate, or irradiation.

7. The method according to claim 1, wherein the conditioning room has an air temperature in a range between 10 and 80 degrees Celsius, preferably in a range between 20 and 60 degrees Celsius, and wherein the conditioning room has an absolute humidity level in a range between 0.05-240 gr H₂O/kg air, preferably between 0.15-85 gr H₂O/kg air, wherein the tray is kept in the conditioning room for 6 to 72 hours.

8. The method according to claim 7, wherein:
for confectionery containing gelatin as gelling agent the conditioning room has an air flow is between 0.2-1.5 m/s, a temperature between 20-35 degrees Centigrade, a humidity between 2-13.5 gr H2O/kg air, and the tray is kept in the conditioning room for 8 to 36 hours;
for confectionery containing pectin as gelling agent the conditioning room has an air flow is between 0.2-1.5 m/s, a temperature between 28-55 degrees Centigrade, a humidity between 2-30-gr H2O/kg air, and the tray is kept in the conditioning room for 6 to 48 hours;
for confectionery containing a combination of gelatin and pectin as gelling agent the conditioning room has an air flow is between 0.2-1.5 m/s, a temperature between 20-35 degrees Centigrade, a humidity between 2-16 gr H2O/kg air, and the tray is kept in the conditioning room for 8 to 48;
for confectionery containing starch as gelling agent the conditioning room has an air flow is between 0.2-1.5 m/s, a temperature between 45-75 degrees Centigrade, a humidity between 2-130 gr H2O/kg air, and the tray is kept in the conditioning room for 30 to 65 hours.

9. The method according to claim 1, wherein prior to removing the confectionery from the tray, the soft confectionery is cooled, wherein cooling is performed in the conditioning room.

10. The method according to claim 1, wherein a plurality of trays are handled in succession in a continuous or batch process.

11. A system for producing soft confectionery, the system including:
a tray for receiving moulding powder, such as starch, wherein the moulding powder has an initial moisture content,
a moulding member for forming one or more mould cavities in the moulding powder,
a depositing unit configured to deposit liquid confectionery in the one or more mould cavities, causing the moisture content of the moulding powder to increase,
a conditioning room configured for drying the soft confectionery,
wherein the system is configured to provide the tray in the conditioning room, wherein conditioning parameters of the conditioning room are adapted such that the confectionery is gelled and dried to a desired extent, and that simultaneously that the moulding powder is dried to a desired moisture content, wherein the desired moisture content is such that the moulding powder is suitable for immediate re-use in subsequent confectionery production.

12. A system including means for carrying out the method according to claim 1.
